(19) United States
(12) Patent Application Publication
(10) Pub. No.: US 2025/0340192 A1
(43) Pub. Date: Nov. 6, 2025

(54) HYDRAULIC PRESSURE CONTROL UNIT AND STRADDLE-TYPE VEHICLE

(71) Applicant: Robert Bosch GmbH, Stuttgart (DE)

(72) Inventor: Wataru Akazawa, Kanagawa (JP)

(21) Appl. No.: 18/870,835

(22) PCT Filed: Jun. 7, 2023
(86) PCT No.: PCT/IB2023/055861

§ 371 Date: Dec. 2, 2024

(30) Foreign Application Priority Data
Jun. 22, 2022 (JP) 2022-100093

(51) Int. Cl. B60T 13/62; B60T 1/06; B60T 8/17; B60T 13/14; B60T 13/68; B60T 13/74; B60T 17/04; B62L 1/00; B62M 7/02

(52) U.S. Cl. CPC B60T 13/62; B60T 13/142; B60T 13/686; B60T 17/04; B62L 1/00; B62M 7/02; B60T 1/065; B60T 8/1706; B60T 13/745

(57) ABSTRACT

The invention obtains a hydraulic pressure control unit for a straddle-type vehicle that facilitates accommodation of a control board in a housing in comparison with a conventional hydraulic pressure control unit.

The hydraulic pressure control unit according to the invention includes: a base body formed with a brake fluid channel; a control board to which at least some of components of a brake controller for controlling a hydraulic pressure regulation valve opening/closing the channel are mounted; a housing accommodating the control board; and a connector electrically connected to the control board. When being observed in a viewing direction that is parallel to an alignment direction of the base body and the housing and in which the base body and the housing are aligned in this order, the connector is provided in an area, which is projected to an outer side of the base body in a first direction as one of four directions extending in an up-down direction and a right-left direction, in the housing, and the housing is also projected to the outer side of the base body in a second direction that is one of the four directions and differs from the first direction.

### BACKGROUND

The present invention relates to a hydraulic pressure control unit for a straddle-type vehicle and to a straddle-type vehicle including the hydraulic pressure control unit.

Conventionally, some vehicles include a hydraulic pressure control unit for controlling a pressure of a brake fluid in a hydraulic circuit that is filled with the brake fluid. For example, in a state where a vehicle occupant operates an input section such as a brake lever, the hydraulic pressure control unit increases/reduces the pressure of the brake fluid in the hydraulic circuit and regulates a braking force to be generated on a wheel, so as to execute anti-lock brake control. In such a hydraulic pressure control unit, a channel constituting a part of the hydraulic circuit, a valve for opening/closing the channel, and the like are unitized (for example, see JP2009107473A).

More specifically, the conventional hydraulic pressure control unit includes: a base body that is formed with a brake fluid channel; and a hydraulic pressure regulation valve that opens/closes the brake fluid channel. The conventional hydraulic pressure control unit also includes: a control board that is mounted with at least some of components of a brake controller for controlling the hydraulic pressure regulation valve; and a housing that accommodates the control board and is connected to the base body. Furthermore, in the conventional hydraulic pressure control unit, the housing is provided with a connector that is electrically connected to the control board.

The conventional hydraulic pressure control unit is manufactured on the basis of the following concept. First, in order to describe the concept, a viewing direction will be defined as follows. The viewing direction is a direction that is parallel to an alignment direction of the base body and the housing and in which the base body and the housing are aligned in this order. When the viewing direction is defined, just as described, and the conventional hydraulic pressure control unit is observed in the viewing direction, only one area provided with the connector in the housing of the conventional hydraulic pressure control unit is projected to an outer side of the base body.

Conventionally, weight reduction of the hydraulic pressure control unit, which is mounted to the straddle-type vehicle as one type of the vehicle, has been requested. For this reason, in recent years, the base body is downsized in the hydraulic pressure control unit mounted to the straddle-type vehicle. Here, the conventional hydraulic pressure control unit, which is mounted to the straddle-type vehicle, is manufactured on the basis of the above-described concept. More specifically, when observed in the viewing direction, only the area provided with the connector in the housing of the conventional hydraulic pressure control unit, which is mounted to the straddle-type vehicle, is projected outward from the base body. For this reason, the conventional hydraulic pressure control unit, which is mounted to the straddle-type vehicle, has a problem of difficulty in accommodating the control board in the housing due to downsizing of the base body.

### SUMMARY

The invention has been made with the above-described problem as the background and therefore has a first purpose of obtaining a hydraulic pressure control unit for a straddle-type vehicle, the hydraulic pressure control unit facilitating accommodation of a control board in a housing in comparison with the related art. The invention has a second purpose of obtaining a straddle-type vehicle that includes such a hydraulic pressure control unit.

A hydraulic pressure control unit according to the invention is a hydraulic pressure control unit for a brake system that is mounted to a straddle-type vehicle, and includes: a base body that is formed with a brake fluid channel; a hydraulic pressure regulation valve that opens/closes the channel; a control board to which at least some of components of a brake controller for controlling the hydraulic pressure regulation valve are mounted; a housing that accommodates the control board and is connected to the base body; and a connector that is provided to the housing and is electrically connected to the control board. When being observed in a viewing direction that is parallel to an alignment direction of the base body and the housing and in which the base body and the housing are aligned in this order, the connector is provided in an area of the housing, the area being projected to an outer side of the base body in a first direction as one of four directions extending in an up-down direction and a right-left direction from a center of the base body. The housing is also projected to the outer side of the base body in a second direction that is one of the four directions and differs from the first direction.

A straddle-type vehicle according to the invention includes the hydraulic pressure control unit according to the invention.

When the hydraulic pressure control unit according to the invention is observed in the above-described viewing direction, a portion of the housing of the hydraulic pressure control unit according to the invention is projected from the base body, and the portion corresponds to a portion, which is not projected from the base body, in the housing of the conventional hydraulic pressure control unit. Accordingly, when the hydraulic pressure control units having the base bodies in the same size are compared, inside of the housing as an accommodation space for the control board in the hydraulic pressure control unit according to the invention is larger than that in the conventional hydraulic pressure control unit. Therefore, the hydraulic pressure control unit according to the invention facilitates accommodation of the control board in the housing in comparison with the conventional hydraulic pressure control unit.

### BRIEF DESCRIPTION OF DRAWINGS

FIG. 1 is a view illustrating a configuration of a straddle-type vehicle, to which a brake system provided with a hydraulic pressure control unit according to an embodiment of the invention is mounted.

FIG. 2 is a view illustrating a configuration of the brake system provided with the hydraulic pressure control unit according to the embodiment of the invention.

FIG. 3 is a perspective view of the hydraulic pressure control unit according to the embodiment of the invention.

FIG. 4 is a perspective view in which the hydraulic pressure control unit according to the invention is observed in an arrow A direction in FIG. 3.

FIG. 5 is a view in which the hydraulic pressure control unit according to the invention is observed in an arrow B direction in FIG. 3.

FIG. 6 is a view in which the hydraulic pressure control unit according to the invention is observed in an arrow C direction in FIG. 5, and is a partial cross-sectional view.

FIG. 7 is a block diagram illustrating a modified example of the hydraulic pressure control unit according to the embodiment of the invention.

FIG. 8 is a view illustrating another modified example of the hydraulic pressure control unit according to the embodiment of the invention.

FIG. 9 is a view illustrating further another modified example of the hydraulic pressure control unit according to the embodiment of the invention.

### DETAILED DESCRIPTION

A description will hereinafter be made on a hydraulic pressure control unit and a straddle-type vehicle according to the invention with reference to the drawings.

The following description will be made on a case where the invention is adopted for a two-wheeled motor vehicle. However, the invention may be adopted for a straddle-type vehicle other than the two-wheeled motor vehicle. Examples of the straddle-type vehicle other than the two-wheeled motor vehicle are a three-wheeled motor vehicle that has at least one of an engine and an electric motor as a drive source, and an all-terrain vehicle. A further example of the straddle-type vehicle other than the two-wheeled motor vehicle is a pedal-driven vehicle. The pedal-driven vehicle means a vehicle in general that can travel forward on a road by a depression force applied to pedals. That is, the pedal-driven vehicles include a normal pedal-driven vehicle, an electrically-assisted pedal-driven vehicle, an electric pedal-driven vehicle, and the like. The two-wheeled motor vehicle or the three-wheeled motor vehicle means a so-called motorcycle, and the motorcycles include a bike, a scooter, an electric scooter, and the like.

A configuration, operation, and the like, which will be described below, merely constitute one example, and each of the hydraulic pressure control unit and the straddle-type vehicle according to the invention is not limited to a case with such a configuration, such operation, and the like. For example, the following description will be made on a case where the hydraulic pressure control unit includes two systems of hydraulic circuits. However, the number of the hydraulic circuit in the hydraulic pressure control unit is not limited to the two systems. The hydraulic pressure control unit may include only one system of the hydraulic circuit or may include three or more systems of the hydraulic circuits.

In the drawings, the same or similar members or portions will be denoted by the same reference sign or will not be denoted by a reference sign. In addition, a detailed structure will appropriately be illustrated in a simplified manner or will not be illustrated. Furthermore, an overlapping description will appropriately be simplified or will not be made.

### Configuration and Operation of Brake System for Straddle-Type Vehicle

A description will be made on a configuration and operation of a brake system according to this embodiment.

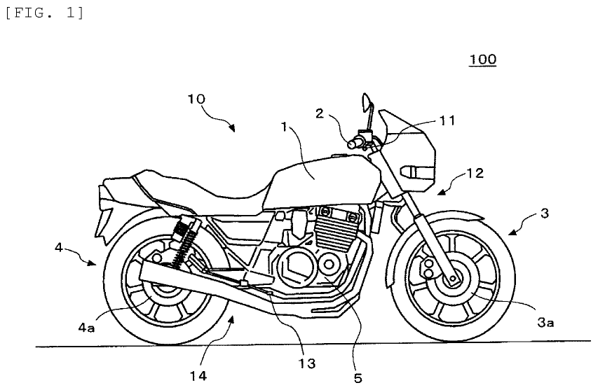

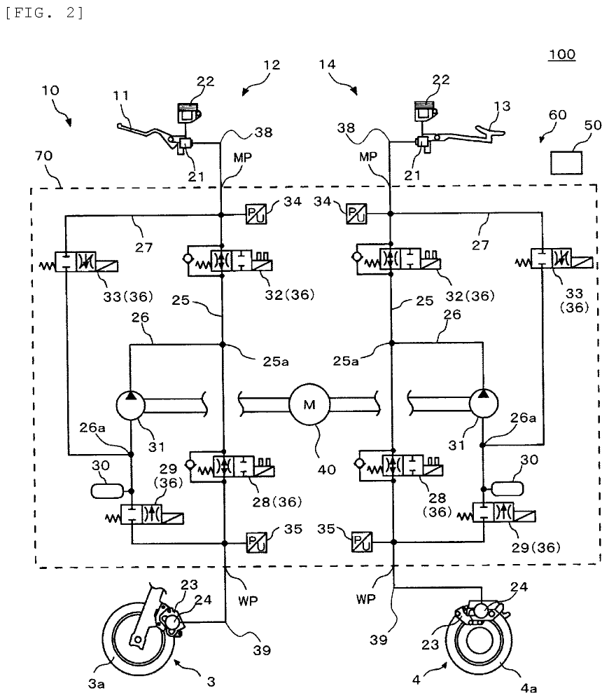

FIG. 1 is a view illustrating a configuration of a straddle-type vehicle, to which the brake system provided with a hydraulic pressure control unit according to the embodiment of the invention is mounted. FIG. 2 is a view illustrating a configuration of the brake system provided with the hydraulic pressure control unit according to the embodiment of the invention.

As illustrated in FIG. 1 and FIG. 2, a brake system 10 is mounted to a straddle-type vehicle 100. The straddle-type vehicle 100 is a two-wheeled motor vehicle that has an engine 5 as a drive source, for example. The straddle-type vehicle 100 includes: a trunk 1; a handlebar 2 that is held by the trunk 1 in a freely turnable manner; a front wheel 3 that is held by the trunk 1 in a freely turnable manner with the handlebar 2; and a rear wheel 4 that is held by the trunk 1 in a freely rotatable manner.

The brake system 10 includes a brake lever 11, a first hydraulic circuit 12 filled with a brake fluid, a brake pedal 13, and a second hydraulic circuit 14 filled with the brake fluid. The brake lever 11 is provided to the handlebar 2 and is operated by a user's hand. The first hydraulic circuit 12 causes a rotor 3a, which rotates with the front wheel 3, to generate a braking force corresponding to an operation amount of the brake lever 11. The brake pedal 13 is provided to a lower portion of the trunk 1 and is operated by the user's foot. The second hydraulic circuit 14 causes a rotor 4a, which rotates with the rear wheel 4, to generate a braking force corresponding to an operation amount of the brake pedal 13.

Each of the brake lever 11 and the brake pedal 13 is an example of a brake input section. For example, as the brake input section that replaces the brake lever 11, a different brake pedal from the brake pedal 13, which is provided to the trunk 1, may be adopted. In addition, for example, as the brake input section that replaces the brake pedal 13, a different brake lever from the brake lever 11, which is provided to the handlebar 2, may be adopted. Furthermore, the first hydraulic circuit 12 may cause the rotor 4a, which rotates with the rear wheel 4, to generate the braking force corresponding to the operation amount of the brake lever 11 or an operation amount of the different brake pedal from the brake pedal 13, which is provided to the trunk 1. Moreover, the second hydraulic circuit 14 may cause the rotor 3a, which rotates with the front wheel 3, to generate the braking force corresponding to the operation amount of the brake pedal 13 or an operation amount of the different brake lever from the brake lever 11, which is provided to the handlebar 2.

The first hydraulic circuit 12 and the second hydraulic circuit 14 have the same configuration. Therefore, a description will hereinafter be made on a configuration of the first hydraulic circuit 12 as a representative example.

The first hydraulic circuit 12 includes: a master cylinder 21 that includes a piston (not illustrated) therein; a reservoir 22 that is attached to the master cylinder 21; a brake caliper 23 that has a brake pad (not illustrated); and a wheel cylinder 24 that operates a brake pad (not illustrated) of the brake caliper 23.

A base body 70 of a hydraulic pressure control unit 60, which is provided to the first hydraulic circuit 12, is formed with brake fluid channels. In this embodiment, the base body 70 is formed with a primary channel 25, a secondary channel 26, and a booster channel 27 as the brake fluid channels. In the first hydraulic circuit 12, the master cylinder 21 and the wheel cylinder 24 communicate with each other via a fluid pipe 38 connected between the master cylinder 21 and a master cylinder port MP formed in the base body 70, the primary channel 25 formed in the base body 70, and a fluid pipe 39 connected between the wheel cylinder 24 and a wheel cylinder port WP formed in the base body 70. The brake fluid in the wheel cylinder 24 is released to a primary channel intermediate section 25a, which is an intermediate section of the primary channel 25, via the secondary channel 26. The brake fluid in the master cylinder 21 is supplied to a secondary channel intermediate section 26a, which is an intermediate section of the secondary channel 26, via the booster channel 27.

In the primary channel 25, an inlet valve 28 is provided in a region on a wheel cylinder 24 side from the primary channel intermediate section 25a. A channel portion, where the inlet valve 28 is installed, in the primary channel 25 is opened/closed by opening/closing operation of the inlet valve 28, respectively, so as to control a flow rate of the brake fluid flowing through this region. In the secondary channel 26, an outlet valve 29 and an accumulator 30, which stores the brake fluid, are provided in this order from the upstream side in a region on an upstream side of the secondary channel intermediate section 26a. A channel portion, where the outlet valve 29 is installed, in the secondary channel 26 is opened/closed by opening/closing operation of the outlet valve 29, respectively, so as to control a flow rate of the brake fluid flowing through this region. In addition, in the secondary channel 26, a pump 31 that applies a pressure to the brake fluid in the secondary channel 26 is provided in a region on a downstream side of the secondary channel intermediate section 26a. In the primary channel 25, a switching valve 32 is provided in region on a master cylinder 21 side from the primary channel intermediate section 25a. A channel portion, where the switching valve 32 is installed, in the primary channel 25 is opened/closed by opening/closing operation of the switching valve 32, respectively, so as to control a flow rate of the brake fluid flowing through this region. A booster valve 33 is provided to the booster channel 27. A channel portion, where the booster valve 33 is installed, in the booster channel 27 is opened/closed by opening/closing operation of the booster valve 33, respectively, so as to control a flow rate of the brake fluid flowing through the booster channel 27.

Hereinafter, in the case where the inlet valve 28, the outlet valve 29, the switching valve 32, and the booster valve 33 for opening/closing the brake fluid channel formed in the base body 70 are collectively referred without distinction, such valves will collectively be referred to as hydraulic pressure regulation valves 36.

In the primary channel 25, a region on the master cylinder 21 side from the switching valve 32 is provided with a master cylinder hydraulic pressure sensor 34 for detecting a hydraulic pressure of the brake fluid in the master cylinder 21. In addition, in the primary channel 25, a region on the wheel cylinder 24 side from the inlet valve 28 is provided with a wheel cylinder hydraulic pressure sensor 35 for detecting a hydraulic pressure of the brake fluid in the wheel cylinder 24.

That is, the primary channel 25 communicates between the master cylinder port MP and the wheel cylinder port WP via the inlet valve 28. Meanwhile, the secondary channel 26 is a channel that is defined as a part or all of a channel from which the brake fluid in the wheel cylinder 24 is released to the master cylinder 21 via the outlet valve 29. Furthermore, the booster channel 27 is a channel that is defined as a part or all of a channel through which the brake fluid in the master cylinder 21 is supplied to a portion on an upstream side of the pump 31 in the secondary channel 26 via the booster valve 33.

The inlet valve 28 is an electromagnetic valve that is switched from allowance to prohibition of a flow of the brake fluid at a mounted position thereof when being brought into an energized state from an unenergized state, for example. The outlet valve 29 is an electromagnetic valve that is switched from prohibition to allowance of a flow of the brake fluid toward the secondary channel intermediate section 26a via a mounted position thereof when being brought into an energized state from an unenergized state, for example. The switching valve 32 is an electromagnetic valve that is switched from allowance to prohibition of a flow of the brake fluid at a mounted position thereof when being brought into an energized state from an unenergized state, for example. The booster valve 33 is an electromagnetic valve that is switched from prohibition to allowance of a flow of the brake fluid toward the secondary channel intermediate section 26a via a mounted position thereof when being brought into an energized state from an unenergized state, for example.

The pump 31 in the first hydraulic circuit 12 and the pump 31 in the second hydraulic circuit 14 are driven by a common motor 40. That is, the motor 40 is a drive source of the pump 31.

The hydraulic pressure control unit 60 is configured to include the base body 70, components (the inlet valves 28, the outlet valves 29, the accumulators 30, the pumps 31, the switching valves 32, the booster valves 33, the master cylinder hydraulic pressure sensors 34, the wheel cylinder hydraulic pressure sensors 35, the motor 40, and the like) provided to the base body 70, and a brake controller (a brake ECU) 50.

The brake controller 50 controls the hydraulic pressure regulation valves 36. The brake controller 50 may be provided as a single unit or may be divided into plural units. In addition, the brake controller 50 may be attached to the base body 70 or may be attached to a member other than the base body 70. Furthermore, the brake controller 50 may partially or entirely be a microcomputer, a microprocessor unit, or the like, may be one whose firmware and the like can be updated, or may be a program module or the like that is executed by a command from a CPU or the like, for example. In the hydraulic pressure control unit 60 according to this embodiment, at least some of components of the brake controller 50 are mounted on a control board 51, which will be described below.

For example, in a normal state, the brake controller 50 controls the inlet valve 28, the outlet valve 29, the switching valve 32, and the booster valve 33 in the unenergized state. When the brake lever 11 is operated in such a state, in the first hydraulic circuit 12, the piston (not illustrated) in the master cylinder 21 is pressed to increase the hydraulic pressure of the brake fluid in the wheel cylinder 24, the brake pad (not illustrated) of the brake caliper 23 is pressed against the rotor 3a of the front wheel 3, and the front wheel 3 is thereby braked. Meanwhile, when the brake pedal 13 is operated, in the second hydraulic circuit 14, the piston (not illustrated) in the master cylinder 21 is pressed to increase the hydraulic pressure of the brake fluid in the wheel cylinder 24, the brake pad (not illustrated) of the brake caliper 23 is pressed against the rotor 4a of the rear wheel 4, and the rear wheel 4 is thereby braked.

The brake controller 50 receives output of each of the sensors (the master cylinder hydraulic pressure sensor 34, the wheel cylinder hydraulic pressure sensor 35, a wheel rotational frequency sensor, an acceleration sensor, and the like). In response to those types of the output, the brake controller 50 outputs a command that governs operation of the motor 40 and the hydraulic pressure regulation valves 36, and performs pressure reducing control operation, pressure boosting control operation, or the like.

For example, in the case where the hydraulic pressure of the brake fluid in the wheel cylinder 24 of the first hydraulic circuit 12 is excessive or is possibly excessive, the brake controller 50 performs operation to reduce the hydraulic pressure of the brake fluid in the wheel cylinder 24 of the first hydraulic circuit 12. At the time, the brake controller 50 drives the motor 40 while controlling the inlet valve 28 in the energized state, controlling the outlet valve 29 in the energized state, controlling the switching valve 32 in the unenergized state, and controlling the booster valve 33 in the unenergized state in the first hydraulic circuit 12. Meanwhile, in the case where the hydraulic pressure of the brake fluid in the wheel cylinder 24 of the second hydraulic circuit 14 is excessive or is possibly excessive, the brake controller 50 performs operation to reduce the hydraulic pressure of the brake fluid in the wheel cylinder 24 of the second hydraulic circuit 14. At the time, the brake controller 50 drives the motor 40 while controlling the inlet valve 28 in the energized state, controlling the outlet valve 29 in the energized state, controlling the switching valve 32 in the unenergized state, and controlling the booster valve 33 in the unenergized state in the second hydraulic circuit 14.

In addition, for example, in the case where the hydraulic pressure of the brake fluid in the wheel cylinder 24 of the first hydraulic circuit 12 is insufficient or is possibly insufficient, the brake controller 50 performs operation to boost the hydraulic pressure of the brake fluid in the wheel cylinder 24 of the first hydraulic circuit 12. At the time, the brake controller 50 drives the motor 40 while controlling the inlet valve 28 in the unenergized state, controlling the outlet valve 29 in the unenergized state, controlling the switching valve 32 in the energized state, and controlling the booster valve 33 in the energized state in the first hydraulic circuit 12. Meanwhile, in the case where the hydraulic pressure of the brake fluid in the wheel cylinder 24 of the second hydraulic circuit 14 is insufficient or is possibly insufficient, the brake controller 50 performs operation to boost the hydraulic pressure of the brake fluid in the wheel cylinder 24 of the second hydraulic circuit 14. At the time, the brake controller 50 drives the motor 40 while controlling the inlet valve 28 in the unenergized state, controlling the outlet valve 29 in the unenergized state, controlling the switching valve 32 in the energized state, and controlling the booster valve 33 in the energized state in the second hydraulic circuit 14.

That is, the hydraulic pressure control unit 60 can perform anti-lock braking operation of the first hydraulic circuit 12 by controlling the hydraulic pressure of the brake fluid in the wheel cylinder 24 of the first hydraulic circuit 12. In addition, the hydraulic pressure control unit 60 can perform the anti-lock braking operation of the second hydraulic circuit 14 by controlling the hydraulic pressure of the brake fluid in the wheel cylinder 24 of the second hydraulic circuit 14. Furthermore, the hydraulic pressure control unit 60 can perform automatic pressure boosting operation of the first hydraulic circuit 12 by controlling the hydraulic pressure of the brake fluid in the wheel cylinder 24 of the first hydraulic circuit 12. Moreover, the hydraulic pressure control unit 60 can perform the automatic pressure boosting operation of the second hydraulic circuit 14 by controlling the hydraulic pressure of the brake fluid in the wheel cylinder 24 of the second hydraulic circuit 14.

### Configuration of Hydraulic Pressure Control Unit

In the hydraulic pressure control unit 60, the base body 70, the hydraulic pressure regulation valves 36, and the control board 51 are unitized. In this embodiment, the members (the motor 40, the master cylinder hydraulic pressure sensor 34, the wheel cylinder hydraulic pressure sensor 35, and the like) other than the hydraulic pressure regulation valves 36 provided to the base body 70 are also unitized with the base body 70 and the control board 51. A description will hereinafter be made on configurations of the unitized components in the hydraulic pressure control unit 60.

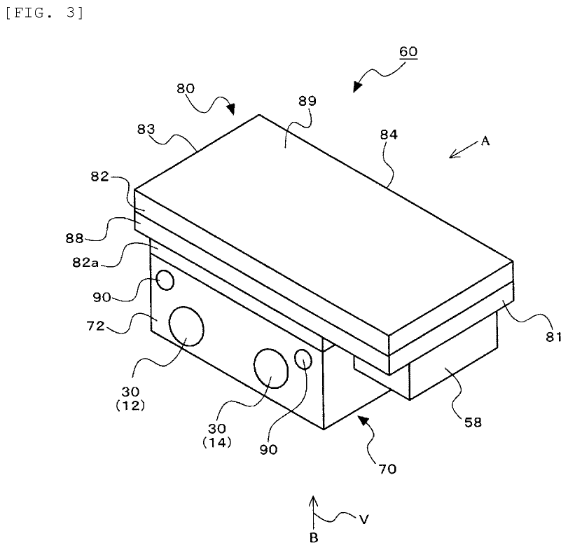

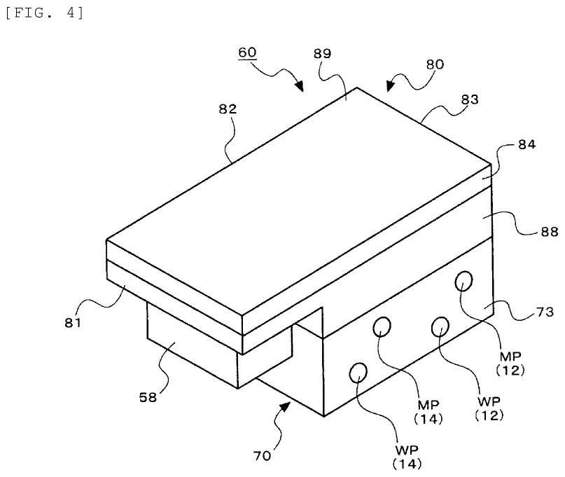

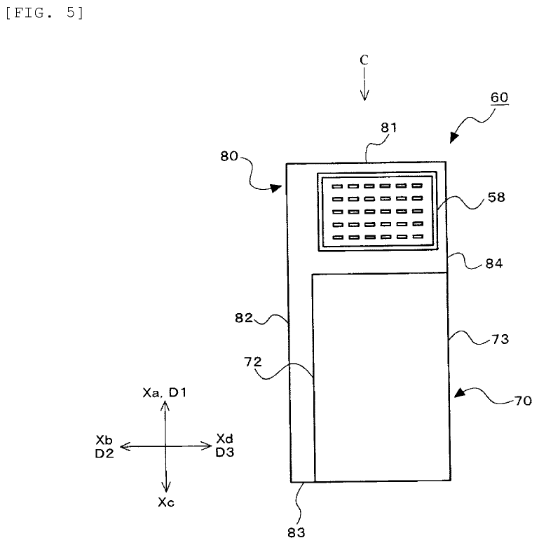

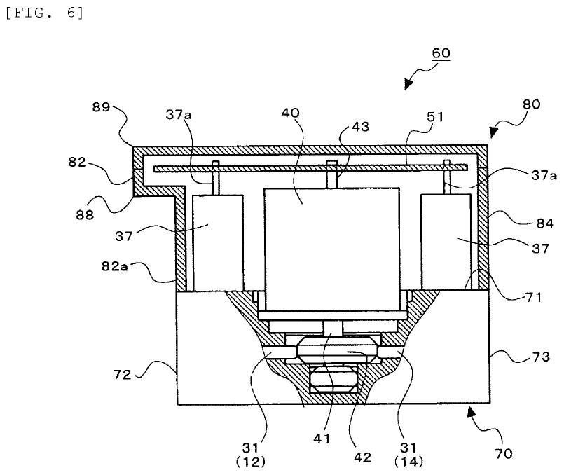

FIG. 3 is a perspective view of the hydraulic pressure control unit according to the embodiment of the invention. FIG. 4 is a perspective view in which the hydraulic pressure control unit according to the invention is observed in an arrow A direction in FIG. 3. FIG. 5 is a view in which the hydraulic pressure control unit according to the invention is observed in an arrow B direction in FIG. 3. FIG. 6 is a view in which the hydraulic pressure control unit according to the invention is observed in an arrow C direction in FIG. 5, and is a partial cross-sectional view.

The base body 70 is formed of metal such as an aluminum alloy and has a substantially rectangular-parallelepiped shape, for example. Each side surface of the base body 70 may be flat, may include a curved portion, or may include a step.

As illustrated in FIG. 6, the motor 40 is provided to a side surface 71 of this base body 70. A structure for fixing the motor 40 to the base body 70 is not particularly limited. For example, the motor 40 may be fixed to the base body 70 by bolting. Alternatively, for example, the motor 40 may be fixed to the base body 70 by so-called caulking.

An eccentric body 42 that rotates with an output shaft 41 of the motor 40 is attached to the output shaft 41 of the motor 40. When the eccentric body 42 rotates, a plunger of the pump 31, which is pressed against an outer circumferential surface of the eccentric body 42, reciprocates. In this way, the brake fluid is delivered from a suction side to a discharge side of the pump 31. This motor 40 is electrically connected to the control board 51, and the output shaft 41 rotates when the control board 51 energizes the motor 40. Although a configuration to electrically connect the control board 51 and the motor 40 is not particularly limited, FIG. 6 exemplifies a configuration to directly connect a terminal 43 of the motor 40 to the control board 51.

In addition, as illustrated in FIG. 6, at least one coil 37 is arranged to the side surface 71 of the base body 70. The coil 37 drives the hydraulic pressure regulation valve 36 that opens/closes the channel formed in the base body 70. In detail, the coil 37 is electrically connected to the control board 51 and moves the plunger of the hydraulic pressure regulation valve 36 with a magnetic force that is generated to the coil 37 by energization from the control board 51, so as to open/close the channel portion, where the hydraulic pressure regulation valve 36 is provided, in the channel formed in the base body 70. For example, in the case where the hydraulic pressure regulation valve 36 is the inlet valve 28, the plunger of the inlet valve 28 is moved by energizing the coil 37, which is provided in a manner to correspond to the inlet valve 28, so as to close the portion, where the inlet valve 28 is installed, in the primary channel 25 in an open state. Although a configuration to electrically connect the control board 51 and the coil 37 is not particularly limited, FIG. 6 exemplifies a configuration to directly connect a terminal 37a of the coil 37 to the control board 51.

The hydraulic pressure control unit 60 includes a housing 80 that accommodates the control board 51. This housing 80 is connected to the side surface 71 of the base body 70. The housing 80 is formed of a resin, for example, and has the substantially rectangular-parallelepiped shape, for example. Each side surface of the housing 80 may be flat, may include a curved portion, or may include a step.

The housing 80 according to this embodiment includes a main body 88 and a lid 89. The main body 88 has a rectangular tube shape, for example, and is connected to the side surface 71 of the base body 70. In a state where the main body 88 is connected to the side surface 71 of the base body 70, the main body 88 surrounds the motor 40 and the coil 37 that are provided to the side surface 71 of the base body 70. The main body 88 is formed with an opening in an area thereof that opposes the control board 51. The lid 89 is attached to the main body 88 and closes the opening. In other words, in the state where the housing 80 is connected to the base body 70, the motor 40 is arranged in a space that is surrounded by the base body 70 and the housing 80.

The hydraulic pressure control unit 60 includes a connector 58 that is electrically connected to the control board 51. A signal wire, a power supply wire, and the like are connected to the connector 58, and the connector 58 is provided to the housing 80. More specifically, the connector 58 is provided at a position, which will be described below, in the housing 80.

In describing the position where the connector 58 is provided, first, a viewing direction V will be described as follows. The viewing direction V is a direction that is parallel to an alignment direction of the base body 70 and the housing 80 and in which the base body 70 and the housing 80 are aligned in this order. That is, the viewing direction V is a direction in which the hydraulic pressure control unit 60 is observed from a lower side of the sheet in FIG. 3, and is the arrow B direction illustrated in FIG. 3. Thus, FIG. 5 is a view in which the hydraulic pressure control unit 60 is observed in the viewing direction V. As illustrated in FIG. 5, in the case where the hydraulic pressure control unit 60 is observed in the viewing direction V, an area of a part of the housing 80 is projected to an outer side of the base body 70. In the case where the hydraulic pressure control unit 60 is observed in the viewing direction V, the connector 58 is provided in the area, which is projected to the outer side of the base body 70, in the housing 80.

By the way, weight reduction of the hydraulic pressure control unit, which is mounted to the straddle-type vehicle, has been requested. For this reason, in recent years, the base body is downsized in the hydraulic pressure control unit mounted to the straddle-type vehicle. Here, when observed in the viewing direction, only the area provided with the connector in the housing of the conventional hydraulic pressure control unit, which is mounted to the straddle-type vehicle, is projected to the outer side of the base body. For this reason, in the conventional hydraulic pressure control unit, which is mounted to the straddle-type vehicle, it has become difficult to accommodate the control board in the housing due to downsizing of the base body. To handle such a problem, the hydraulic pressure control unit 60 according to this embodiment adopts the following configuration in order to facilitate the accommodation of the control board 51 in the housing 80 in comparison with the conventional hydraulic pressure control unit.

In describing the configuration of the hydraulic pressure control unit 60 according to this embodiment, as illustrated in FIG. 5, four directions, which extend in an up-down direction and a right-left direction from a center of the base body 70 when the hydraulic pressure control unit 60 is observed in the viewing direction V, are set as a direction Xa, a direction Xb, a direction Xc, and a direction Xd. Each of the above four directions is a direction from the center of the base body 70. However, when actually illustrated at the center of the base body 70, the four directions hide the shape of the hydraulic pressure control unit 60. For this reason, in FIG. 5 and the following drawings, the above four directions are illustrated at positions shifted from the base body 70. In FIG. 5 and the following drawings, the direction Xa is an up direction on the sheet, the direction Xb is a left direction on the sheet, the direction Xc is a down direction on the sheet, and the direction Xd is a right direction on the sheet. Hereinafter, when the hydraulic pressure control unit 60 is observed in the viewing direction V, a direction from the base body 70 toward the connector 58 is aligned with the direction Xa, and the hydraulic pressure control unit 60 is then observed. In addition, hereinafter, the direction Xa is also referred to as a first direction D1. That is, when the hydraulic pressure control unit 60 is observed in the viewing direction V, the connector 58 is provided in the area, which is projected to the outer side of the base body 70 in the first direction D1, in the housing 80. In this embodiment, when the hydraulic pressure control unit 60 is observed in the viewing direction V, the connector 58 and the base body 70 are aligned along a longitudinal direction of the base body 70.

When the hydraulic pressure control unit 60 is observed in the viewing direction V with the direction Xa being the first direction D1, just as described, the housing 80 of the hydraulic pressure control unit 60 according to this embodiment is also projected to the outer side of the base body 70 in a second direction D2, which differs from the first direction D1 as one of the four directions. In other words, when the hydraulic pressure control unit 60 is observed in the viewing direction V with the direction Xa being the first direction D1, the side surfaces that define a contour of the housing 80 are a side surface 81, a side surface 82, a side surface 83, and a side surface 84. Of these, the side surface 81 is a side surface that defines the contour of the housing 80 in the direction Xa, which is the first direction D1, of the four directions. The side surface 82 is a side surface that defines the contour of the housing 80 in the direction Xb, which is not the first direction D1, of the four directions. The side surface 83 is a side surface that defines the contour of the housing 80 in the direction Xc, which is not the first direction DI, of the four directions. The side surface 84 is a side surface that defines the contour of the housing 80 in the direction Xd, which is not the first direction D1, of the four directions. When the hydraulic pressure control unit 60 is observed in the viewing direction V with the direction Xa being the first direction DI, in the housing 80 of the hydraulic pressure control unit 60 according to this embodiment, the side surface 81 is projected to the outer side of the base body 70, and at least one of the side surface 82, the side surface 83, and the side surface 84 is also projected to the outer side of the base body 70. In the hydraulic pressure control unit 60 according to this embodiment, the direction Xb is the second direction D2. In other words, in the hydraulic pressure control unit 60 according to this embodiment, when the hydraulic pressure control unit 60 is observed in the viewing direction V with the direction Xa being the first direction DI, the side surface 82 is projected to the outer side of the base body 70. Further in other words, in the hydraulic pressure control unit 60 according to this embodiment, when the hydraulic pressure control unit 60 is observed in the viewing direction V, the side surface 82 is a side surface that defines the contour of the housing 80 in the second direction D2.

That is, when the hydraulic pressure control unit 60 is observed in the viewing direction V, the portion of the housing 80 of the hydraulic pressure control unit 60 according to this embodiment is projected from the base body 70, the portion corresponding to the portion, which is not projected from the base body, in the housing of the conventional hydraulic pressure control unit. In other words, when the hydraulic pressure control units having the base bodies in the same size are compared, inside of the housing 80 as an accommodation space for the control board 51 in the hydraulic pressure control unit 60 according to this embodiment is larger than that in the conventional hydraulic pressure control unit. Accordingly, as illustrated in FIG. 6, in the hydraulic pressure control unit 60 according to this embodiment, the control board 51 can be arranged to the portion of the housing 80, the portion corresponding to the portion, which is not projected from the base body, in the housing of the conventional hydraulic pressure control unit. Therefore, the hydraulic pressure control unit 60 according to this embodiment facilitates the accommodation of the control board 51 in the housing 80 in comparison with the conventional hydraulic pressure control unit.

When the hydraulic pressure control unit 60 is observed in the viewing direction V, the side surface 82, which defines the contour of the housing 80 in the second direction D2, may entirely be projected to the outer side of the base body 70. However, in this embodiment, the side surface 82 is partially projected to the outer side of the base body 70. More specifically, the side surface 82 of the housing 80 is connected, at its end on a base body 70 side, to the base body 70. Thus, a connected section 82a of the side surface 82 with the base body 70 is an area including the end on the base body 70 side. In this embodiment, when the hydraulic pressure control unit 60 is observed in the viewing direction V, the connected section 82a with the base body 70 in the side surface 82 of the housing 80 is not projected to the outer side of the base body 70.

The hydraulic pressure control unit 60 is mounted to the straddle-type vehicle 100 as described above. In this case, a side surface 72 of the base body 70 is an attachment surface to the straddle-type vehicle 100. In other words, when the hydraulic pressure control unit 60 is mounted to the straddle-type vehicle 100, the side surface 72 of the base body 70 is attached to an attachment member, such as a bracket of the straddle-type vehicle 100. Thus, as illustrated in FIG. 3, an attachment section 90 is provided to the side surface 72. More specifically, in the hydraulic pressure control unit 60 according to this embodiment, the side surface 72 is formed with a female screw as the attachment section 90. However, the female screw is merely an example of the attachment section 90. The attachment section 90 may appropriately be determined according to an attachment configuration to the straddle-type vehicle 100. For example, as the attachment section 90, a stud may be provided vertically on the side surface 72. In FIG. 3, the configuration other than the attachment section 90 illustrated on the side surface 72 is the accumulator 30.

Here, the side surface 72 of the base body 70 is a side surface that defines a contour of the base body 70 in the direction Xb as the second direction D2 when the hydraulic pressure control unit 60 is observed in the viewing direction V. That is, in the hydraulic pressure control unit 60 according to this embodiment, the side surface 72, which defines the contour of the base body 70 in the second direction D2 when the hydraulic pressure control unit 60 is observed in the viewing direction V, is the attachment surface.

By the way, as described above, the base body 70 is formed with the master cylinder port MP and the wheel cylinder port WP. The master cylinder port MP is a port that communicates with the primary channel 25 and to which the fluid pipe 38 communicating with the master cylinder 21 is connected. The wheel cylinder port WP is a port that communicates with the primary channel 25 and to which the fluid pipe 39 communicating with the wheel cylinder 24 is connected. At least one of these master cylinder port MP and wheel cylinder port WP is formed in the side surface as described below of the side surfaces of the base body 70.

In this embodiment, of the above-described four directions at the time when the hydraulic pressure control unit 60 is observed in the viewing direction V, the direction Xa is the first direction D1, and the direction Xb is the second direction D2. Thus, in the case where the direction, which is neither the first direction D1 nor the second direction D2 of the above-described four directions at the time when the hydraulic pressure control unit 60 is observed in the viewing direction V, is defined as a third direction D3, either one of the direction Xc and the direction Xd can be the third direction D3. In this embodiment, the direction Xd is set as the third direction D3. As illustrated in FIG. 4, a side surface 73, which defines the contour of the base body 70 in the third direction D3 when the hydraulic pressure control unit 60 is observed in the viewing direction V, is formed with at least one of the master cylinder port MP and the wheel cylinder port WP. More specifically, in this embodiment, both of the master cylinder port MP and the wheel cylinder port WP in the first hydraulic circuit 12 and both of the master cylinder port MP and the wheel cylinder port WP in the second hydraulic circuit 14 are formed in the side surface 73 of the base body 70. In addition, in this embodiment, the housing 80 is configured not to be projected to the outer side of the base body 70 in the direction Xd as the third direction D3 when the hydraulic pressure control unit 60 is observed in the viewing direction V.

### Effects of Hydraulic Pressure Control Unit

A description will be made on effects of the hydraulic pressure control unit 60 according to this embodiment.

The hydraulic pressure control unit 60 is the hydraulic pressure control unit for the brake system 10 that is mounted to the straddle-type vehicle 100. The hydraulic pressure control unit 60 includes the base body 70, the hydraulic pressure regulation valves 36, the control board 51, the housing 80, and the connector 58. The base body 70 is formed with the brake fluid channels. Each of the hydraulic pressure regulation valves 36 is the valve that opens/closes the respective brake fluid channel formed in the base body 70. The control board 51 is a board to which at least some of the components of the brake controller 50 for controlling the hydraulic pressure regulation valves 36 are mounted. The housing 80 accommodates the control board 51. The housing 80 is connected to the base body 70. The connector 58 is provided to the housing 80 and is electrically connected to the control board 51. The direction that is parallel to the alignment direction of the base body 70 and the housing 80 and in which the base body 70 and the housing 80 are aligned in this order is set as the viewing direction V. When the hydraulic pressure control unit 60 is observed in the viewing direction V, the connector 58 is provided in the area, which is projected to the outer side of the base body 70 in the first direction DI as one of the four directions extending in the up-down direction and the right-left direction from the center of the base body 70, in the housing 80. The housing 80 is also projected to the outer side of the base body 70 in the second direction D2, which is one of the four directions and differs from the first direction D1, when the hydraulic pressure control unit 60 is observed in the viewing direction V.

In the thus-configured hydraulic pressure control unit 60, when being observed in the viewing direction V, the portion of the housing 80, which corresponds to the portion of the conventional hydraulic pressure control unit not projected from the base body, is projected from the base body 70. In other words, when the hydraulic pressure control units having the base bodies in the same size are compared, the inside of the housing 80 as the accommodation space for the control board 51 in the thus-configured hydraulic pressure control unit 60 is larger than that in the conventional hydraulic pressure control unit. Therefore, the thus-configured hydraulic pressure control unit 60 facilitates the accommodation of the control board 51 in the housing 80 in comparison with the conventional hydraulic pressure control unit.

Preferably, the motor 40 is arranged in the space surrounded by the base body 70 and the housing 80.

In the case where the motor 40 is arranged in the space surrounded by the base body 70 and the housing 80, it may be concerned that heat generated by the motor 40 affects the control board 51. However, when the hydraulic pressure control units having the base bodies in the same size are compared, the control board 51 in a large size can be mounted to the hydraulic pressure control unit 60 according to this embodiment in comparison with the control board mounted to the conventional hydraulic pressure control unit. Thus, a heat dissipation property of the control board 51 is improved. For this reason, in the hydraulic pressure control unit 60 according to this embodiment, even in the case where the motor 40 is arranged in the space that is surrounded by the base body 70 and the housing 80, it is possible to suppress the heat generated by the motor 40 from affecting the control board 51 in comparison with the conventional hydraulic pressure control unit. Therefore, the hydraulic pressure control unit 60 according to this embodiment facilitates the arrangement of the motor 40 in the space surrounded by the base body 70 and the housing 80 in comparison with the conventional hydraulic pressure control unit.

Preferably, of the housing 80, the connected section 82a with the base body 70 in the side surface 82, which defines the contour of the housing 80 in the second direction D2 when being observed in the viewing direction V, is not projected to the outer side of the base body 70.

In the thus-configured hydraulic pressure control unit 60, at least a part of a portion, which is not an accommodation space for the control board 51, in the housing 80 is not projected from the base body 70. Thus, an amount of a material that is used to form the housing 80 can be suppressed. Therefore, weight of the thus-configured hydraulic pressure control unit 60 can be reduced in comparison with a case where the entire side surface 82 is projected to the outer side of the base body 70.

Preferably, the side surface 72, which defines the contour of the base body 70 in the second direction D2 when being observed in the viewing direction V, in the base body 70 is the attachment surface to the straddle-type vehicle 100.

The thus-configured hydraulic pressure control unit 60 is arranged such that the portion, which is projected to the outer side of the base body 70, in the housing 80 overlaps the attachment member of the straddle-type vehicle 100 when the hydraulic pressure control unit 60 is attached to the attachment member of the straddle-type vehicle 100. Therefore, in regard to the thus-configured hydraulic pressure control unit 60, it is possible to reduce the space for mounting the hydraulic pressure control unit 60 to the straddle-type vehicle 100.

Preferably, of the base body 70, the side surface 73 defines the contour of the base body 70 in the third direction D3, which is one of the four directions and differs from the first direction D1 and the second direction D2, when being observed in the viewing direction V, and the side surface 73 is formed with at least one of the master cylinder port MP and the wheel cylinder port WP. When the hydraulic pressure control unit 60 is observed in the viewing direction V, the housing 80 is not projected to the outer side of the base body 70 in the third direction D3.

In the thus-configured hydraulic pressure control unit 60, in the case where the side surface 73 is formed with the master cylinder port MP, it is easy to connect the fluid pipe 38 to the master cylinder port MP and to handle the fluid pipe 38. In addition, in the thus-configured hydraulic pressure control unit 60, in the case where the side surface 73 is formed with the wheel cylinder port WP, it is easy to connect the fluid pipe 39 to the wheel cylinder port WP and to handle the fluid pipe 39.

Preferably, when the hydraulic pressure control unit 60 is observed in the viewing direction V, the connector 58 and the base body 70 are aligned along the longitudinal direction of the base body 70.

In general, as one side of the opening of the connector is extended, a sealing property and the like of the connector worsen. For this reason, conventionally, the opening of the connector has a substantially square shape. Accordingly, in the case where the connector 58 and the base body 70 are aligned along a short direction of the base body 70 when the hydraulic pressure control unit 60 is observed in the viewing direction V, an excess area is formed on a side of the connector 58 in a perpendicular direction to the alignment direction of the connector 58 and the base body 70. Meanwhile, in the case where the connector 58 and the base body 70 are aligned along the longitudinal direction of the base body 70 when the hydraulic pressure control unit 60 is observed in the viewing direction V, it is possible to suppress the formation of the excess area. In this way, it is possible to reduce amounts of materials used to form the control board 51, the housing 80, and the like, which are arranged in the excess area, and thus to reduce the weight of the hydraulic pressure control unit 60.

### Modified Examples

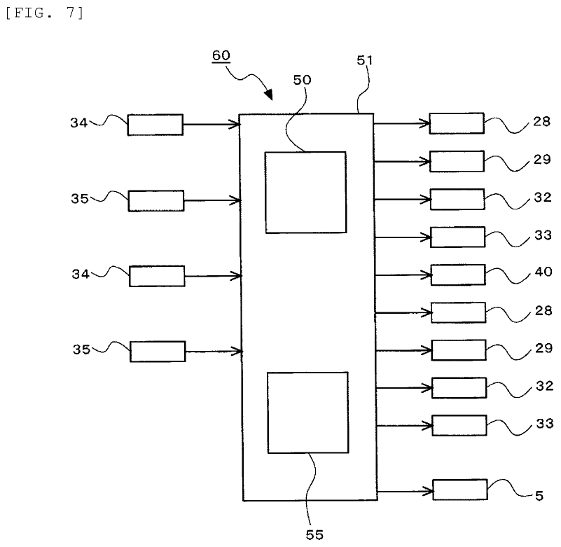

FIG. 7 is a block diagram illustrating a modified example of the hydraulic pressure control unit according to the embodiment of the invention.

Conventionally, when the brake controller (the brake ECU) of the hydraulic pressure control unit controls the braking force on the wheel, an engine controller (an engine ECU) may cooperate with the brake controller to control engine output, so as to further improve vehicle safety. Here, as described above, the control board 51 in the larger size can be mounted to the hydraulic pressure control unit 60 according to this embodiment in comparison with the conventional hydraulic pressure control unit. Thus, as illustrated in FIG. 7, in the hydraulic pressure control unit 60, at least some of components of an engine controller 55, which controls output of the engine 5 of the straddle-type vehicle 100, can be mounted to the control board 51. FIG. 7 illustrates an example in which all of the components of the brake controller 50 are mounted to the control board 51 and all of the components of the engine controller 55 are mounted to the control board 51. Meanwhile, in the case where the straddle-type vehicle 100 includes an electric motor as the drive source instead of the engine, the engine controller 55 controls output of the electric motor.

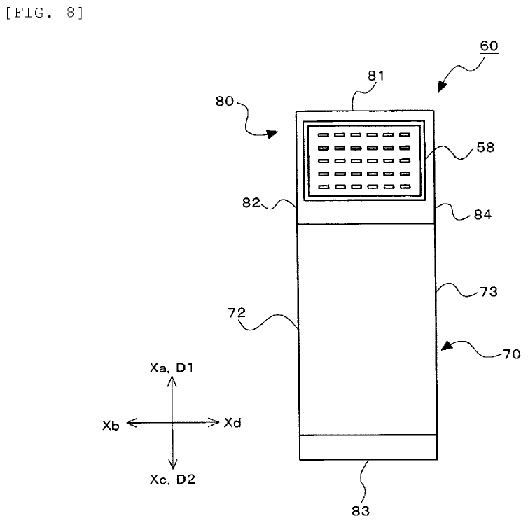

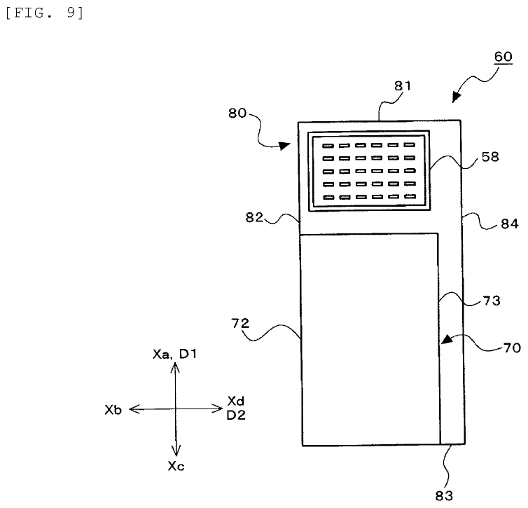

FIG. 8 and FIG. 9 are views, each of which illustrates a modified example of the hydraulic pressure control unit according to the embodiment of the invention. In each of FIG. 8 and FIG. 9, the modified example of the hydraulic pressure control unit 60 according to this embodiment is observed in the viewing direction V.

In the above-described hydraulic pressure control unit 60, the direction Xb is the second direction D2. That is, in the above-described hydraulic pressure control unit 60, when the hydraulic pressure control unit 60 is observed in the viewing direction V, the side surface 82 of the housing 80 is projected to the outer side of the base body 70. However, the second direction D2 only needs to be the direction other than the direction Xa, which is the first direction D1, of the four directions.

For example, as illustrated in FIG. 8, when the hydraulic pressure control unit 60 is observed in the viewing direction V, the direction Xc may be set as the second direction D2. In other words, as illustrated in FIG. 8, when the hydraulic pressure control unit 60 is observed in the viewing direction V, the side surface 83 of the housing 80 may be projected to the outer side of the base body 70. Alternatively, for example, as illustrated in FIG. 9, when the hydraulic pressure control unit 60 is observed in the viewing direction V, the direction Xd may be set as the second direction D2. In other words, as illustrated in FIG. 9, when the hydraulic pressure control unit 60 is observed in the viewing direction V, the side surface 84 of the housing 80 may be projected to the outer side of the base body 70. Further alternatively, for example, when the hydraulic pressure control unit 60 is observed in the viewing direction V, each of the direction Xb and the direction Xc may be set as the second direction D2. In this case, when the hydraulic pressure control unit 60 is observed in the viewing direction V, each of the side surface 82 and the side surface 83 of the housing 80 is projected to the outer side of the base body 70. For example, when the hydraulic pressure control unit 60 is observed in the viewing direction V, each of the direction Xb and the direction Xd may be set as the second direction D2. In this case, when the hydraulic pressure control unit 60 is observed in the viewing direction V, each of the side surface 82 and the side surface 84 of the housing 80 is projected to the outer side of the base body 70. For example, when the hydraulic pressure control unit 60 is observed in the viewing direction V, each of the direction Xc and the direction Xd may be set as the second direction D2. In this case, when the hydraulic pressure control unit 60 is observed in the viewing direction V, each of the side surface 83 and the side surface 84 of the housing 80 is projected to the outer side of the base body 70. For example, when the hydraulic pressure control unit 60 is observed in the viewing direction V, each of the direction Xb, the direction Xc, and the direction Xd may be set as the second direction D2. In this case, when the hydraulic pressure control unit 60 is observed in the viewing direction V, each of the side surface 82, the side surface 83, and the side surface 84 of the housing 80 is projected to the outer side of the base body 70.

Also, in the thus-configured hydraulic pressure control unit 60, when being observed in the viewing direction V, the portion of the housing 80, which corresponds to the portion of the conventional hydraulic pressure control unit not projected from the base body, is projected from the base body 70. Therefore, the thus-configured hydraulic pressure control unit 60 also facilitates the accommodation of the control board 51 in the housing 80 in comparison with the conventional hydraulic pressure control unit.

The description has been made so far on the hydraulic pressure control unit 60 according to this embodiment. However, the hydraulic pressure control unit according to the invention is not limited to that in the description of this embodiment. In regard to the hydraulic pressure control unit according to the invention, only a part thereof in this embodiment may be implemented.

### REFERENCE SIGNS LIST

1: Trunk
2: Handlebar
3: Front wheel
3a: Rotor
4: Rear wheel
4a: Rotor
5: Engine
10: Brake system
11: Brake lever
12: First hydraulic circuit
13: Brake pedal
14: Second hydraulic circuit
21: Master cylinder
22: Reservoir
23: Brake caliper
24: Wheel cylinder
25: Primary channel
25a: Primary channel intermediate section
26: Secondary channel
26a: Secondary channel intermediate section
27: Booster channel
28: Inlet valve
29: Outlet valve
30: Accumulator
31: Pump
32: Switching valve
33: Booster valve
34: Master cylinder hydraulic pressure sensor
35: Wheel cylinder hydraulic pressure sensor
36: Hydraulic pressure regulation valve
37: Coil
37a: Terminal
38: Fluid pipe
39: Fluid pipe
40: Motor
41: Output shaft
42: Eccentric body
43: Terminal
50: Brake controller
51: Control board
55: Engine controller
58: Connector
60: Hydraulic pressure control unit
70: Base body
71: Side surface
72: Side surface
73: Side surface
80: Housing
81: Side surface
82: Side surface
82a: Connected section
83: Side surface
84: Side surface
88: Main body
89: Lid
90: Attachment section
100: Straddle-type vehicle
MP: Master cylinder port
WP: Wheel cylinder port
V: Viewing direction
Xa: Direction
Xb: Direction
Xc: Direction
Xd: Direction
D1: First direction
D2: Second direction
D3: Third direction

1. A hydraulic pressure control unit (60) for a brake system (10) that is mounted to a straddle-type vehicle (100), the hydraulic pressure control unit (60) comprising:
a base body (70) that is formed with a channel (25, 26, 27) for a brake fluid;
a hydraulic pressure regulation valve (36) that opens/closes the channel (25, 26, 27);
a control board (51) to which at least some of components of a brake controller (50) for controlling the hydraulic pressure regulation valve (36) are mounted;
a housing (80) that accommodates the control board (51) and is connected to the base body (70); and
a connector (58) that is provided to the housing (80) and is electrically connected to the control board (51), wherein
when being observed in a viewing direction (V) that is parallel to an alignment direction of the base body (70) and the housing (80) and in which the base body (70) and the housing (80) are aligned in this order,
the connector (58) is provided in an area of the housing (80), the area being projected to an outer side of the base body (70) in a first direction (D1) as one of four directions extending in an up-down direction and a right-left direction from a center of the base body (70), and
the housing (80) is also projected to the outer side of the base body (70) in a second direction (D2) that is one of the four directions and differs from the first direction (D1).

2. The hydraulic pressure control unit (60) according to claim 1 further comprising:
a motor (40) as a drive source of a pump (31) that applies a pressure to the brake fluid in the channel (26), wherein
the motor (40) is arranged in a space that is surrounded by the base body (70) and the housing (80).

3. The hydraulic pressure control unit (60) according to claim 1, wherein
at least some of components of an engine controller (55) are mounted to the control board (51), the engine controller (55) controlling output of an engine (5) of the straddle-type vehicle (100).

4. The hydraulic pressure control unit (60) according to claim 1, wherein
of the housing (80), a connected section (82a) with the base body (70) in a side surface (82) is not projected to the outer side of the base body (70), the side surface (82) defining a contour of the housing (80) in the second direction (D2) when being observed in the viewing direction (V).

5. The hydraulic pressure control unit (60) according to claim 1, wherein
a side surface (72) of the base body (70) is an attachment surface to the straddle-type vehicle (100), the side surface (72) defining a contour of the base body (70) in the second direction (D2) when being observed in the viewing direction (V).

6. The hydraulic pressure control unit (60) according to claim 1, wherein
a side surface (73) of the base body (70) is formed with at least one of: a master cylinder port (MP) that communicates with the channel (25) and to which a fluid pipe (38) communicating with a master cylinder (21) is connected; and a wheel cylinder port (WP) that communicates with the channel (25) and to which a fluid pipe (39) communicating with a wheel cylinder (24) is connected, the side surface (73) defining a contour of the base body (70) in a third direction (D3) that is one of the four directions and differs from the first direction (D1) and the second direction (D2) when being observed in the viewing direction (V), and
the housing (80) is not projected to the outer side of the base body (70) in the third direction (D3) when being observed in the viewing direction (V).

7. The hydraulic pressure control unit (60) according to claim 1, wherein
the connector (58) and the base body (70) are aligned along a longitudinal direction of the base body (70) when being observed in the viewing direction (V).

8. A straddle-type vehicle (100) comprising:
the hydraulic pressure control unit (60) according to claim 1.
